(19) United States
(12) Patent Application Publication
(10) Pub. No.: US 2023/0105060 A1
(43) Pub. Date: Apr. 6, 2023

(54) Bottle Opener With Customizable Tool

(71) Applicants: Emilie Myers, Cardiff, CA (US); Michael R. Myers, Cardiff, CA (US)

(72) Inventors: Emilie Myers, Cardiff, CA (US); Michael R. Myers, Cardiff, CA (US)

(21) Appl. No.: 17/492,042

(22) Filed: Oct. 1, 2021

(51) Int. Cl. B67B 7/44; B67B 7/16; B67B 7/04; A63B 57/50; A63B 45/02; B25G 1/08; A63B 57/30; A63B 57/35

(52) U.S. Cl. CPC B67B 7/44; B67B 7/16; B67B 7/0411; A63B 57/50; A63B 45/02; B25G 1/08; A63B 57/353; A63B 57/35

(57) ABSTRACT

A bottle opener having the shape of a human hand provides a handle and cap gripping component which is configured for removing a conventional bottle cap in a compressed fit upon a bottle. The configuration provides cap removal in a direction toward the user with less effort. The cap gripping component can be configured to removably engage the handle where a tool such as a golf divot tool can be stored within an interior of the handle.

### FIELD OF THE INVENTION

The present device relates to bottle openers for removing crimped caps from bottles. More particularly, the device herein relates to a hand shaped bottle opener having a cavity-housed tool engaged thereto which can be customized for multiple uses.

### BACKGROUND OF THE INVENTION

For decades manufacturers of drinks such as soda and beer, have provided such in bottles and more recently cans, which hold the liquid drink sealed within the container until the buyer opens it for use. In the case of glass bottled beverages, especially those which are carbonated, many manufacturers employ a metal cap which is crimped to seal the bottle opening.

Such beverage containers frequently have a metal bottle cap affixed to the rim of the neck of a bottle. During a crimping of the metal cap, the circumference of the cap becomes pleated or ruffled around the rim. To remove such pleated and compression engaged caps, a bottle opener is conventionally employed. Such bottle openers conventionally are configured as a specialized lever, with one side thereof which inserted beneath the pleated metalwork on the side of the cap adjacent the user.

Thereafter, with a ledge of the opener positioned underneath an edge of the cap on the side of the cap closest to the user, the user removes the cap by lifting the distal end of the lever in a direction away from their person. During this hand actuated lifting of the opener member a point on the bottle cap functions as a fulcrum on which to pivot and remove the cap. The cap, in such conventional configurations of bottle openers is pulled from the compressive engagement to the bottle, and it dismounts on the opposite side of the bottle from the contact point of the ledge of the opener with the cap, and the hand of the user holding it.

The forgoing examples of hand actuated bottle cap openers and the like are intended to be illustrative and not exclusive, and they do not imply any limitations on the invention described and claimed herein. Various other limitations of the related art are known or will become apparent to those skilled in the art upon a reading and understanding of the specification below and the accompanying drawings.

### SUMMARY OF THE INVENTION

The device herein disclosed features a two-piece construction which includes a bottle cap gripping component on one end and an elongated lever extending therefrom. The elongated handle or member is removably connected to the cap gripping component with mating connectors positioned on both the cap gripping component and a second end of the elongated handle. By mating connectors is meant that a first mating connector on the cap gripping component is removably connectable with a second mating connector positioned on the second end of the handle, such as with threads, bayonet style mounts, sliding connectors or twist and lock connectors, or any other mating connectors as would occur to those skilled in the art.

Particularly preferred in all modes of the device herein, is the configuration of the cap gripping component in the form of a human hand. It was found during experimentation that forming the cap gripping component as a hand, rendered the device intuitively engageable to the correct position to remove the cap. Additionally preferred is a configuration of the cap gripping component with a ledge which is positionable underneath an edge of the cap to be removed, where that edge is on the opposite side of the cap from the user. This configuration was found to provide a much easier dismount of compression engaged metal caps as it formed the fulcrum employed to lift the opposite side of the cap, closer to the user than the ledge engaging the cap.

Using this configuration, the cap is disengaged in a direction toward the user, and the fulcrum located closer to the user thereby requiring less force to remove the cap. This is significant in that with conventional openers, which position the fulcrum on the side of the cap opposite the user, more gripping strength is required to overcome the force exerted on the fulcrum point, to hold the bottle upright during cap removal. Additionally, it was found that the rotational force exerted on the arm of the user gripping the bottle was less where the fulcrum of the opener is positioned on the side of the cap closer to the user. Forming the cap gripping component in the shape of the hand was found to render the proper engagement of the device intuitive to the users who are used to engaging conventional openers, which places the ledge removing the cap on the opposite side from the device herein. As such, the hand appearance of the cap gripping component is preferred.

Additionally provided in the device herein, is one or a plurality of tools which may be removably engaged to a first end of the cap gripping component. The device can be provided with permanently engaged tools for use in specific endeavors, such as a divot repair tool having a ball marking stencil for golf use, or with permanently engaged tools adapted for other uses such as surfing or skating.

However, also preferred is the provision of the device wherein the cap gripping component is removably engageable to any of a kit of tools. Each of the tools is configured with one half of a cooperative fastener which engages with a second half of a cooperative fastener located on the cap gripping component. Such a configuration with a kit of engageable tools allows the user to choose the appropriate tool to connect, depending on their upcoming task or play.

In all modes of the device herein, the handle which removably engages with the cap gripping component, has an interior cavity running axially within a sidewall surrounding the interior cavity. The permanent or chosen tool is positioned within this interior cavity when the cap gripping component is removably engaged to the handle. The exterior of the sidewall defining the handle is employed for gripping by a hand of the user during removal of a bottle cap.

In a particularly preferred mode of the device herein employable for golfing, a ball marker is engaged to the exterior of the handle at a first end thereof. It is preferable that the means for engagement is a magnetic attraction between the ball marker and the first end of the handle. Such allows the user to temporarily remove the marker without having to open or disengage the components of the device to mark a ball position and to easily re-mount it once finished.

Also particularly preferred, in the mode of the device employing a divot tool, is the formation of a ball marking stencil communicating through the member forming the divot tool. This stencil allows the user to mark their golf balls with a player identifier by holding the stencil adjacent the ball and using a marker to place the shape of the stencil on the ball. This stencil can be a custom shaped player identifier, or can be provided with a standard identifier.

With respect to the above description, before explaining at least one preferred embodiment of the herein disclosed bottle opener with engageable tools in detail, it is to be understood that the invention is not limited in its application to the details of construction and to the arrangement of the components in the following description or illustrated in the drawings. The bottle opener invention herein described and shown is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other bottle opening devices and for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. Where used, if not otherwise defined, the term “substantially” means plus or minus ten percent.

It is an object of the present invention to provide a bottle cap opener which is configured to place the fulcrum thereof adjacent the user and pull the cap from the opposite side and toward the user.

It is another object of the invention herein, to form the cap gripping component of the device in a configuration to encourage the user to intuitively position the cap gripping component in a correct engagement with the cap.

It is an additional object of this invention to provide such a bottle cap opener which includes a fixed or a removably engageable tool housed within the handle which is adapted to user for the sport or task anticipated by a user.

These and other objects, features, and advantages of the present bottle opener system, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive examples of embodiments and/or features of the disclosed bottle opener with engageable tools. It is intended that the embodiments and figures disclosed herein are to be considered illustrative of the invention herein, rather than limiting in any fashion.

In the drawings:

FIG. 1 depicts an exterior view of the device in an assembled configuration with the handle removably engaged to a cap gripping component.

FIG. 2 depicts an exploded view of a mode of the device of FIG. 1, but common to all, wherein a tool is engaged to the cap gripping component and is stored within the handle and showing a magnetically engaged position marker.

FIG. 3 depicts the device as shown in FIGS. 1-2 wherein the sidewall of the handle is removed to show the interior cavity into which the tool projects for storage.

FIG. 4 shows a disengaged view of the handle from the cap gripping component wherein the tools engaged are screwdrivers.

FIG. 5 shows a disengaged view of a mode of the device herein wherein the tool engaged with the cap gripping component is a cork screw.

FIG. 6 depicts a mode of the device with the handle disengaged from the cap gripping component which has a hex wrench tool engaged thereto having a screw driver positioned therein.

FIG. 7 shows the device herein in an engaged position where it is in operative engagement to a bottle cap, wherein a fulcrum is positioned on the handle side of the device and the cap is removed in a direction toward the user holding the handle.

FIG. 8 shows a kit of tools which may be provided for users to engage with the cap gripping component.

FIGS. 9-14 depict various side, end, and perspective views of the exterior of the device wherein the cap gripping component appears as a human hand.

### DETAILED DESCRIPTION OF THE INVENTION

In this description, the directional prepositions of up, upwardly, down, downwardly, front, back, top, upper, bottom, lower, left, right and other such terms refer to the device as it is oriented and appears in the drawings and are used for convenience only and such are not intended to be limiting or to imply that the device has to be used or positioned in any particular orientation.

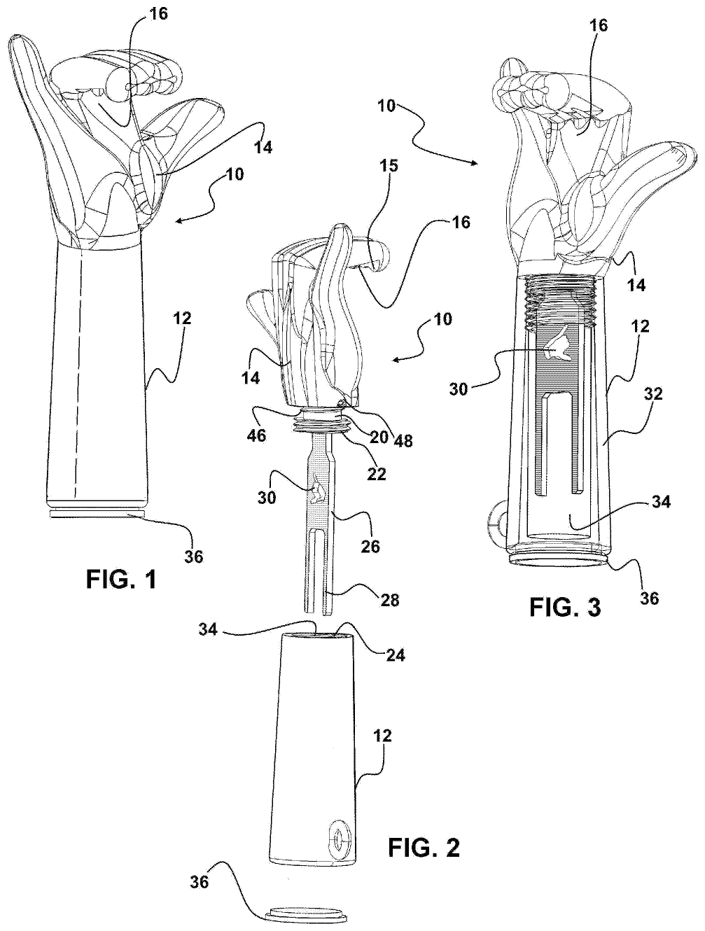

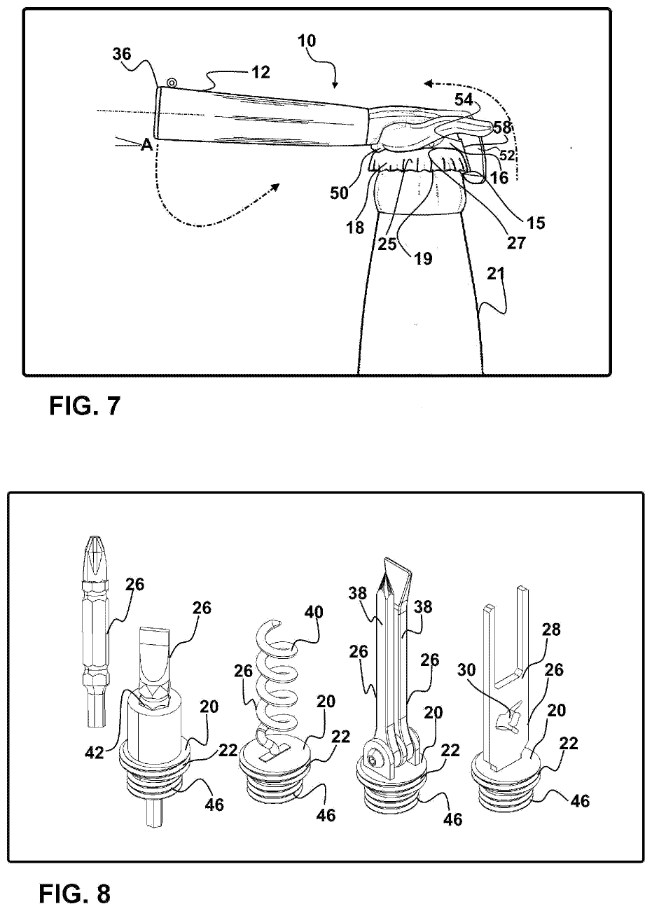

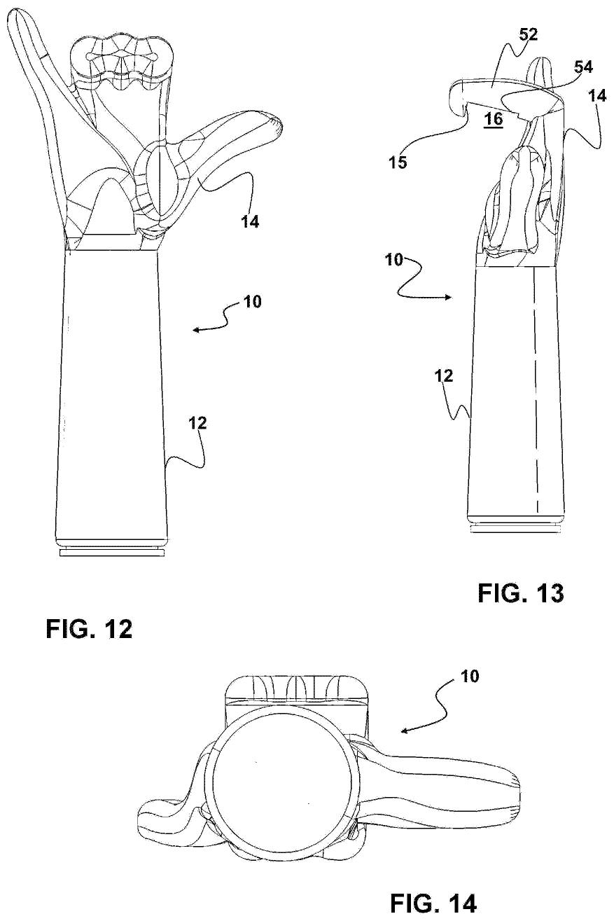

Now referring to drawings in FIGS. 1-14, wherein similar components are identified by like reference numerals, there is seen in FIG. 1 an exterior view of the bottle opener device 10 herein common to all modes herein, shown in an assembled configuration. In this configuration, the handle 12 is removably engaged to a cap gripping component 14. The cap gripping component 14 is configured in the shape appearing as a human hand which has been shown in experimentation as a means to help users intuitively properly position the device 10 as in FIG. 7, to remove the bottle cap 18 (FIG. 7) from a conventional bottle. The cap gripping component 14 has a cap cavity 16 configured to engage over a conventional bottle cap 18 (FIG. 7) for removal of the bottle cap 18 with a mount 52 having an angled surface substantially matching the angle of the side of a conventional bottle cap, in contact with the side surface of the bottle cap on a side thereof opposite the user holding it. In this engaged position, shown in FIG. 7, a ledge 15 at the distal edge of the mount 52 is in contact with an underside edge of the cap 18, while the angled surface 58 formed by the interior edge 54 is in substantially full contact with the outwardly angled side surface of the bottle cap 18.

In FIG. 2 is shown an exploded view of the device 10 of FIG. 1 and common to all configurations herein. As shown, a connector 20 is engaged at a first end with the cap gripping component 14. This may be a permanent engagement or, more preferably, a removable engagement of fasteners on the connector 20 with mating fasteners on the cap gripping connector 14 such as by using threads or other mating fasteners.

At a second end of the connector 20 is positioned a handle fastener 22 such as threads which will removably engage with mating handle fasteners 24 on a first end of the handle 12. Of course the handle fastener 22 which removably engage with the mating handle fastener 24, may be other mating fasteners which will engage and disengage as needed such as frictional connectors or a slot and twist type bayonet mount, or other means for removably engaging the handle 12 to the cap gripping component 14 as would occur to those skilled in the art. Also, while a connector 20 is shown as the interface connection, the cap gripping component 14 could also simply have the handle fastener 22 formed as part thereof, so long as the first end of the cap gripping component 14 is in a removable engagement to the first end of the handle 12.

Shown in FIG. 2 also, is a tool 26 connected to the first end of the cap gripping component 14. As shown, the tool 2 is configured as a divot repair tool 28 used widely in golf. By the term divot repair tool 28 is meant a conventional forked tool employed widely in golf to reposition turf which has been disturbed by the golfer. Also shown in FIG. 2, and particularly preferred, is a stencil 30 which communicates through the member forming the divot repair tool 28. This stencil 30 is employable by the user to draw an identifier on a golf ball by easily tracing a marker within the edge of the stencil 30. This allows the user to place an identifier on their golf ball so that during play it can be identified and associated to the user having the device 10 herein.

The stencil 30 can be formed in any shape such as family crest or initial, or any other shape, or can be provided as standard configurations chosen by the user. In the mode of the device 10, configured specifically for golf, the tool 26 forming the divot tool 28 can be provided in a standard configuration. In other modes of the device 10, the user can purchase or choose one of a plurality of tools 26 provided in a kit of available tools 26 such as shown in FIG. 8.

In FIG. 3 is depicted the device 10, as shown in FIGS. 1-2, wherein a portion of the sidewall 32 defining the handle 12 shape and size, and also defining an interior cavity 34 of the handle 12 is removed to better show the interior cavity 34 into which the tool 26 projects for storage. While shown with the divot repair tool 28 having the favored stencil 30 therein, any of the tools from the kit in FIG. 8 could be positioned within the interior cavity 34 when in a connection with the first end of the cap gripping component 14.

Additionally depicted in FIGS. 2-3, and provided in combination with the divot repair tool 28, is a position marker 36. This position marker 36 is preferably in a magnetic connection with the handle 12 at a first end such as the end opposite the cap gripping connector 14. As shown in FIG. 2, the position marker 36 has been separated from its magnetic connection to the handle 12 and in FIG. 3 it has been re-engaged. By the term magnetic connection is meant the position marker 36 and/or the handle 12 have a magnet thereon, and magnetic attraction is formed between the position marker 36 to hold it in contact against the handle 12, by the formed magnetic attraction. By the term position marker 36 is meant a marker for the position of a golf ball on the golf course when the golf ball is temporarily removed from the course such as at a putting green.

Such for example can be a magnet positioned on the handle 12 and forming the position marker 36 with magnetically attractive metal, or reversing such and placing the magnet on the position marker 36 which will magnetically engage with magnetically attractive metal on the handle 12. When the device 10 is provided pre-configured for golf, the device 10 will preferably include both the divot repair tool 28 with a stencil 30 as well as the position marker 36.

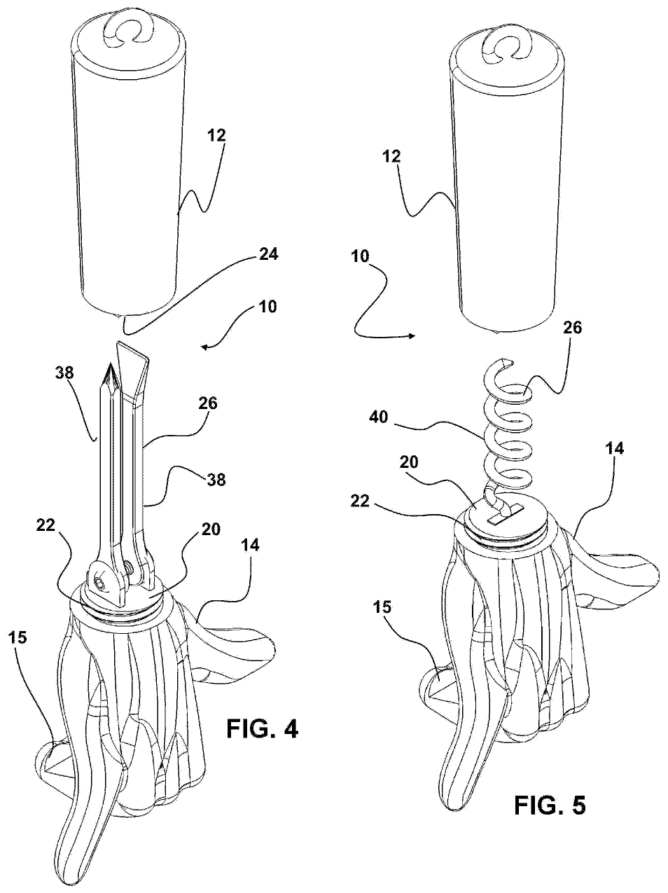

In FIG. 4 is shown, a disengaged view of the handle 12 from the cap gripping component 14. Re-engagement is achieved using the removable engagement of the first end of the handle 12 to the first end of the cap gripping component 14. As noted and shown, this removable engagement may be formed by a handle fastener 22, shown as a threaded end of the connector 20, which will removably engage with the mating handle fastener 24 positioned at the first end of the handle 12, such as threads formed on the sidewall 30 which mate with the threaded end of the connector 20.

Also shown in FIG. 4 is the tool 26 which, as depicted, is formed of a plurality of screwdrivers 38 engaged to the connector 20. As shown in FIG. 8, this connector 20 can be operatively connected to any of the tools 26 shown in the kit of tools of FIG. 8, which may be the screwdrivers 38, a cork screw 40, the divot tool 28, or a skate tool 42. The kit shown in FIG. 8 can be provided to the user with a purchase of the device 10 or available for initial and subsequent provision of different tools 26.

The employment of the connector 20 works best to allow the user to engage one or any of a plurality of tools 26 to the cap gripper component 14 from the kit available. The connector 20 is configured with the handle fastener 22 on one end, and has a second fastener 46 on the opposite end to engage the connector 20 with a mating second fastener 48 on the first end of the cap gripping component 14. As shown the second fastener 46 is depicted as threads which will connect with complimentary threads forming the mating second fastener 48 within a recess on the first end of the cap gripping component 14. However, other removable connections to form a removable engagement of the connectors 20 to the cap gripping component 14 may be employed such as a twist lock, bayonet mount, or ball and detent, or others those skilled in the art may employ.

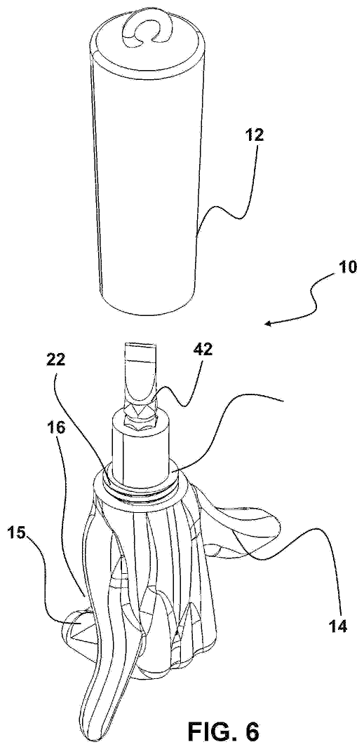

In FIG. 5 is depicted a mode of the device 10 having the handle separated from the removable engagement of the first end thereof with the first end of the cap gripping component 14. As shown, a cork screw 40 forms the tool 26. The cork screw 40 is engaged with the connector 20 such as with a set screw, solder, welding, or other means for engagement of one end thereof to the connector 20. As shown, the connector 20 is in a removable engagement to the cap gripping component 14 using the secondary fastener 46 (FIG. 8) formed as threads which engage with the mating secondary fastener 48 (FIG. 3) formed of complimentary threads positioned within a cavity in the cap gripping component 14, such as in FIG. 2.

In FIG. 6 is shown the device 10 having a tool 26 extending from an engagement to the connector 20, where the tool is a skate too 42. The first end of the handle 12 forms a removable engagement to the cap gripping component 14 using the handle fastener 22 which removably connect with the mating handle fastener 24 (FIG. 4). As with other modes, the connector 20 has the secondary fastener 46 such as threads(FIG. 8) engaged with the mating secondary fastener 48 formed as threads in a cavity at the first end of the cap gripping component 14 as in FIG. 2.

Operation of the device 10 is shown in FIG. 7, wherein the device 10 is positioned to an engaged position with a bottle cap 18. In the engaged position, the bottle cap 18 is operatively positioned within the cap cavity 16 with a ledge 15 formed on the second end of the cap gripping component 14 positioned under and in contact against a lower edge 19 of the bottle cap 18. As is well known, such conventional bottle caps 18 are in a compressed engagement with bottles 21 they seal. In this compressed engagement a side surface 26 of the bottle cap 18 has an outward angle from the smaller circumference of the top surface of the cap 27, to a larger circumference located at the lower edge 19 of the bottle cap 18.

With the device 10 in the engaged position of FIG. 7 and the bottle cap 18 positioned within the cap cavity 16, a fulcrum 50 is formed at a contact point between the cap gripping component 14 and a first side of the bottle cap 18, opposite the second side of the bottle cap 18 on which the ledge 15 engages.

With the device in the engaged position with the bottle cap 18 positioned in the cap cavity 16 with the ledge 15 in contact with the lower edge 19 of the bottle cap 18 at the second side of the bottle cap 18 opposite the side from which the handle 12 is projection, the user holding the handle 12 can push the handle 12 downward toward the underlying bottle 21 on the side they are holding it. This removal, as noted above, is preferred as it allows users to exert more force on the handle 12 while holding the bottle 21. This is because the positioning of the ledge 15 at the second side of the bottle cap 18 locates the fulcrum 50 closer to the user, allowing the user to push the handle 12 toward the bottle 21 which the user is holding or pulling toward the handle 12.

Experimentation showed that users more easily controlled the forces exerted when pushing their hands toward each other rather than pushing them away from each other when using conventional bottle openers. As such, the positioning of the ledge 15 at the second side of the bottle cap 18 and the interior edge 54 extending at an angle substantially matching that of the side surface 25 of the bottle cap 18 in contact with the side surface 25, thereby locates the fulcrum 50 at the first side of the bottle cap 18 during use. Additionally, as shown in FIG. 7, the angle A of the axis of the handle 12, is either substantially parallel to the top surface 27 of the bottle cap 18, or at an upward angle of substantially 25 degrees from the planar top surface 27, with the device 10 in the engaged position which also makes it easier for the user to remove the bottle cap 18.

As noted, shown in FIG. 8 is a current kit of tools 26 each of which may be placed in a removable engagement with the first end of the cap gripping component 14. As shown the various tools 26 are engaged with the connector 20. Each connector 20 has a secondary fastener 46 which will form a removable connection to a mating secondary fastener 48 at the first end of the cap gripping component 14 such as complimentary threads (FIG. 2) to those threads forming the secondary connector 46.

Each connector 20 also has a handle fastener 22. With the connector in a removable connection with the cap gripping component 14, the handle fastener 22 is employed to form the removable engagement or connection of the cap gripping component 14 to the handle 12. Any of the tools in the kit such as in FIG. 8, can be engaged to the device 10. As noted, particularly preferred for golf is the inclusion of the divot repair tool 28 which includes the stencil 30.

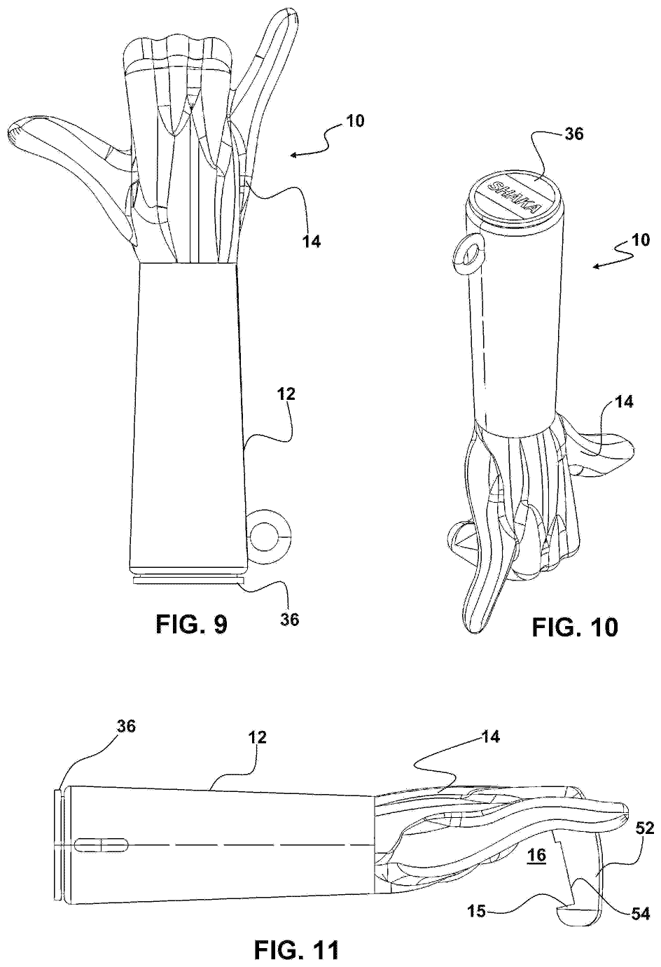

FIGS. 9-14 depict various side, end, and perspective views of the exterior of the device 10 in an assembled configuration with the cap gripping component 14 in a removable connection to the handle 12. For example, in FIG. 10 is shown the position marker 36 magnetically connected to the handle 12.

Shown in FIGS. 11 and 13 are side views of the device 10 showing side views of the cap cavity 16. As shown, a mount 52 at the second end of the cap gripping component 14 extends toward a bottom end of the cap cavity 16, and has the ledge 15 extending from a distal end of the mount 50. Also shown are an interior edge 54 of the mount 52 which runs at an angle relative to the axis 56 of the handle 12. This angle preferably substantially matches the exterior angled surface 58 of a conventional bottle cap 18 such as shown in FIG. 7.

As noted above, the views of the device in FIGS. 9-14 show the cap gripping component 14 formed to appear as a human hand when viewed by a user holding the handle 12. As also noted, this configuration appeared to render positioning of the device 10 to remove a bottle cap 18 such as shown in FIG. 7, intuitive to the user, and is preferred

It should be noted that any of the different depicted and described configurations and tools and components of the disclosed bottle opener herein, can be employed with any other configuration or component or tool shown and described as part of the device herein. Additionally, while the present invention has been described herein with reference to particular embodiments thereof and/or steps in use, a latitude of modifications, various changes and substitutions are intended in the foregoing disclosure, and it will be appreciated that in some instance some features, or configurations, of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

Further, the purpose of any abstract of this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. Any such abstract is neither intended to define the invention of the application, which is measured by the claims, nor is it intended to be limiting, as to the scope of the invention in any way.

What is claimed is:

1. A bottle opener comprising:
a handle having a first end and a second end;
a cap gripping component;
said cap gripping component having a first end and a distal end;
said first end of said cap gripping component being in an engagement with said second end of said handle;
a mount extending from said distal end of said cap gripping component;
said mount having an interior edge extending to a ledge positioned on a distal end of said mount;
said cap gripping component having a cap cavity positioned between a first end thereof and said interior edge of said mount and said ledge;
said bottle opener having an engaged position wherein a bottle cap engaged upon a bottle is positioned within said cap cavity;
said ledge in contact with a lower edge of said bottle cap with said bottle opener in said engaged position; and
wherein the exerting of a downward force by a user on said first end of said handle dismounts said cap from said bottle.

2. The bottle opener of claim 1 additionally comprising:
said cap gripping component having the appearance of a human hand.

3. The bottle opener of claim 1 additionally comprising:
said handle extending in a direction away from said interior edge and toward said user exerting said downward force with said bottle opener in said engaged position.

4. The bottle opener of claim 1 additionally comprising:
said handle extending in a direction away from said interior edge and toward said user exerting said downward force with said bottle opener in said engaged position.

5. The bottle opener of claim 3 additionally comprising:
said interior edge of said mount extending along said mount at a mount angle which is substantially equal to a cap angle of the side surface of said bottle cap, wherein said interior edge forms an angled contact with said side surface.

6. The bottle opener of claim 4 additionally comprising:
said interior edge of said mount extending along said mount at a mount angle which is substantially equal to a cap angle of the side surface of said bottle cap, wherein said interior edge forms an angled contact with said side surface.

7. The bottle opener of claim 1 additionally comprising:
said engagement of said first end of said cap gripping with said second end of said handle being a removable engagement;
said handle having an interior cavity;
a tool, said tool having a first end connected to said first end of said cap gripping component;
said tool positioned within said interior cavity with said first end of said cap gripping component engaged to said second end of said handle.

8. The bottle opener of claim 2 additionally comprising:
said engagement of said first end of said cap gripping with said second end of said handle being a removable engagement;
said handle having an interior cavity;
a tool, said tool having a first end connected to said first end of said cap gripping component;
said tool positioned within said interior cavity with said first end of said cap gripping component engaged to said second end of said handle.

9. The bottle opener of claim 5 additionally comprising:
said engagement of said first end of said cap gripping with said second end of said handle being a removable engagement;
said handle having an interior cavity;
a tool, said tool having a first end connected to said first end of said cap gripping component;
said tool positioned within said interior cavity with said first end of said cap gripping component engaged to said second end of said handle.

10. The bottle opener of claim 6 additionally comprising:
said engagement of said first end of said cap gripping with said second end of said handle being a removable engagement;
said handle having an interior cavity;
a tool, said tool having a first end connected to said first end of said cap gripping component;
said tool positioned within said interior cavity with said first end of said cap gripping component engaged to said second end of said handle.

11. The bottle opener of claim 7 additionally comprising:
said tool being a golf divot tool, said golf divot tool having an opening communicating therethrough, and
said opening defining a stencil for marking a shape of said opening upon a golf ball.

12. The bottle opener of claim 8 additionally comprising:
said tool being a golf divot tool, said golf divot tool having an opening communicating therethrough, and
said opening defining a stencil for marking a shape of said opening upon a golf ball.

13. The bottle opener of claim 9 additionally comprising:
said tool being a golf divot tool, said golf divot tool having an opening communicating therethrough, and
said opening defining a stencil for marking a shape of said opening upon a golf ball.

14. The bottle opener of claim 10 additionally comprising:
said tool being a golf divot tool, said golf divot tool having an opening communicating therethrough, and
said opening defining a stencil for marking a shape of said opening upon a golf ball.

15. The bottle opener of claim 7 additionally comprising:
said first end of said tool being removably connected to said first end of said cap gripping component;
a kit of tools, said kit of tools including a golf divot tool, a screwdriver, a cork screw, and a skate tool; and
each of said tools in said kit of tools being removably connectable at a first end thereof to said first end of said cap gripping component.

16. The bottle opener of claim 8 additionally comprising:
said first end of said tool being removably connected to said first end of said cap gripping component;
a kit of tools, said kit of tools including a golf divot tool, a screwdriver, a cork screw, and a skate tool; and
each of said tools in said kit of tools being removably connectable at a first end thereof to said first end of said cap gripping component.

17. The bottle opener of claim 9 additionally comprising:
said first end of said tool being removably connected to said first end of said cap gripping component;
a kit of tools, said kit of tools including a golf divot tool, a screwdriver, a cork screw, and a skate tool; and
each of said tools in said kit of tools being removably connectable at a first end thereof to said first end of said cap gripping component.

18. The bottle opener of claim 10 additionally comprising:
said first end of said tool being removably connected to said first end of said cap gripping component;
a kit of tools, said kit of tools including a golf divot tool, a screwdriver, a cork screw, and a skate tool; and
each of said tools in said kit of tools being removably connectable at a first end thereof to said first end of said cap gripping component.

19. The bottle opener of claim 1 additionally comprising:
a position marker, said position marker in a magnetic engagement to said first end of said handle; and
said position marker removable from said handle to temporarily designate the position of a golf ball removed from the course.

20. The bottle opener of claim 7 additionally comprising:
a position marker, said position marker in a magnetic engagement to said first end of said handle; and
said position marker removable from said handle to temporarily designate the position of a golf ball removed from the course.
